(19) United States
(12) Patent Application Publication
(10) Pub. No.: US 2011/0202661 A1
(43) Pub. Date: Aug. 18, 2011

(54) SESSION-BASED TELECOMMUNICATIONS

(75) Inventor: Sait Sener, Istanbul (TR)

(73) Assignee: VODAFONE GROUP PLC, Newbury, Berkshire (GB)

(21) Appl. No.: 12/988,300

(22) PCT Filed: Apr. 15, 2009
(86) PCT No.: PCT/GB09/50376

§ 371 Date: Apr. 19, 2011

(30) Foreign Application Priority Data
Apr. 17, 2008 (TR) 2008/02671

(51) Int. Cl. G06F 15/16

(52) U.S. Cl. 709/227

(57) ABSTRACT

A method for establishing bi-directional and session-based communication between IMS and GSM subscribers with the purpose of sending text information by using the SIP protocol and USSD services. The method defines an IP-USSD gateway that converts messages between the SIP and USSD protocols before relaying them. The communication session can be initiated by either party; the GSM subscriber or the IMS subscriber. A message, which an SIP client has sent, is thereby converted into a USSD message and conveyed to the GSM subscriber. Thus, the GSM subscriber can read the USSD message sent to the mobile phone, and in addition can see the name and surname of the sender and write an answer. Similarly, the SIP subscriber can read the message received and write an answer.

The present invention relates to a method and system for establishing bi-directional and session based communication between IMS (Internet Protocol Multimedia Subsystem) network subscribers and GSM network subscribers. In particular, the invention relates to the provision of text based sessions for the exchange of information in text format.

Instant messaging (IM) is a popular facility in the “fixed” world of computing—allowing the users of two or more geographically distributed, networked computers to exchange text messages in near real-time. Implementing “mobile” IM is considerably complicated by the heterogeneous natures of wireless (cellular) networks and the terminals that operate over those networks. A barrier to acceptance of mobile IM is the difficulty of setting up and maintaining realtime exchanges of text between subscribers of advanced networks, which offer a range of sophisticated chat and information services (e.g. IMS networks), and subscribers of GSM networks, with more limited native service offerings.

There are two main classes of conventional techniques for transferring text messages between IMS network subscribers (using SIP, Session Initiation Protocol, clients) and GSM network subscribers.

In one technique, GSM mobile subscribers install SIP client applications of their own onto their phones and connect to IP (Internet Protocol) networks over GPRS (General Packet Radio Service) and WCDMA (Wideband Code Division Multiple Access). Verbal or written communication with corresponding SIP clients on IMS networks (and thus the IMS subscriber) is mediated with these applications.

Alternatively, IMS networks and the GSM networks may interface via an IP Short Message Gateway, thereby providing the bi-directional communication. In this case, the messages sent by the IMS subscribers' SIP clients are converted (by the IP-SMS gateway) into SMS messages for the GSM network subscribers. In the opposite direction, the SMS messages are converted into SIP messages.

The first class of technique can only be applied to GSM phones that are specified to provide GPRS connectivity. Indeed, for a number of reasons, including compatibility and access to legacy hardware components, it is not possible to install an appropriate SIP client application on the phone of every GSM subscriber.

Furthermore, not all GSM subscribers have access to (or want to use) a GPRS connection or a terminal that enables the GPRS connection. GPRS coverage may not be available at all in certain cases. In parts of the world, GSM subscribers may share the use of a terminal (swapping SIM cards as required)—the installation of a SIP client application in such circumstances may not be appropriate or desirable.

The second class of technique is applicable to all GSM phones that support SMS, however, as it is not session based, this solution is not interactive or conversational.

A further difficulty is presented when a pre-paid GSM subscriber is “roaming” outside the home network for that subscriber—in this situation they cannot benefit from either class of service at all.

It is an object of the invention to obviate or at least mitigate the above problems.

In accordance with one aspect of the present invention, there is provided a method for facilitating session-based text message communications between a first communications network and a second communications network, the first communications network being operable to deliver Internet Protocol multimedia services and the second communications network being operable to deliver messages that conform to a session-based message protocol, the method comprising: receiving a session request signal from a given one of said communications networks, said session request signal including a text message; translating the received request signal into a session request signal capable of being transported over the other of said communications networks; and relaying the translated request signal to said other communications network, thereby establishing a text message communications session between the networks.

Preferably, the method further comprises: receiving a session response signal from said other communications network; translating the received response signal into a session response signal capable of being transported over said given communications network; and relaying the translated response signal to said other communications network. The session response signal may in this case include a further text message.

In an instance of the operation of the invention, the session request signal may be received from the first communications network and conform to the Session Initiation Protocol.

Alternatively, the session request signal may be received from the second communications network and conform to a session-based message protocol.

Conveniently, the text message includes name-surname information of the subscriber, from whom the session request signal originates.

The invention thus provides bi-directional and session based communication with the purpose of sending text information between SIP clients in IMS networks and GSM mobile subscribers by using the SIP and USSD protocols.

The user experience resulting from the invention is improved by virtue of the more immediate character of USSD (Unstructured Supplementary Service Data) messaging. Using the SIP and USSD protocols for facilitating text message exchanges means that instant messaging sessions can be made to feel more “conversational”—with considerably shorter

As the invention is suitable for use with the USSD service, it can be implemented in GSM networks without needing networks supporting GPRS or above. In addition, the USSD service can be implemented in any type of mobile phone and no other application is needed to be loaded on.

The method has a further benefit for the operator of any cellular telecommunications network as it consumes less in the way of network resources (e.g. much lower bandwidth) than a comparable, conventional text message (SMS) exchange or the exchange of messages between SIP clients.

Another advantage of the invention is that when prepaid subscribers roam in different countries, they can use the USSD service and set up communication. This is not possible using prior art techniques.

In addition, during the interactive correspondence, the invention is able to send name-surname information related to IMS subscribers, who started the communication. Prior art techniques, only allow the sending of the phone number of the IMS subscriber, who started the communication.

In accordance with another aspect of the present invention, there is provided apparatus for facilitating session-based text message communications between a first communications network and a second communications network, the first communications network being operable to deliver Internet Protocol multimedia services and the second communications network being operable to deliver messages that conform to a session-based message protocol, the apparatus comprising: first network interface for receiving session request signals from said first communications network and second network interface for receiving session request signals from said second communications network, said session request signals including text messages; and a translator which is operable to convert received request signals from a given one of said communications networks into translated session request signals capable of being transported over the other of said communications networks; wherein the first network interface and second network interface are further operable to relay the translated request signal to said other communications network, thereby establishing a text message communications session between the communications networks.

The translator is preferably an IP-USSD Gateway residing between said first communications network and said second communications network.

Preferably, session request signals received from the first communications network may conform to the Session Initiation Protocol and may be converted into translated session request signals conforming to the USSD message protocol.

Equally preferably, session request signals received from the second communications network may conform to the USSD message protocol and may be converted into translated session request signals conforming to the Session Initiation Protocol.

For a better understanding of the present invention, reference will now be made, by way of example only, to the accompanying drawings in which:—

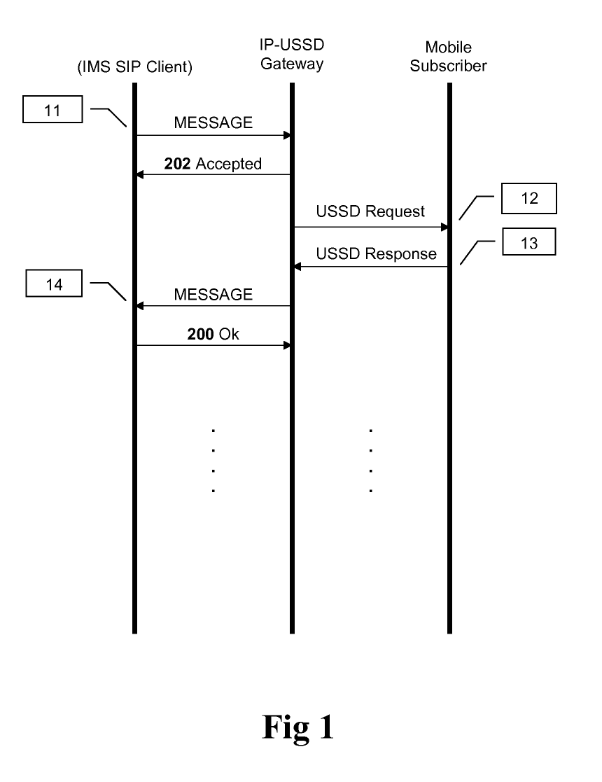

FIG. 1 shows graphically the signalling steps for a text-based dialogue started by the IMS subscriber; and

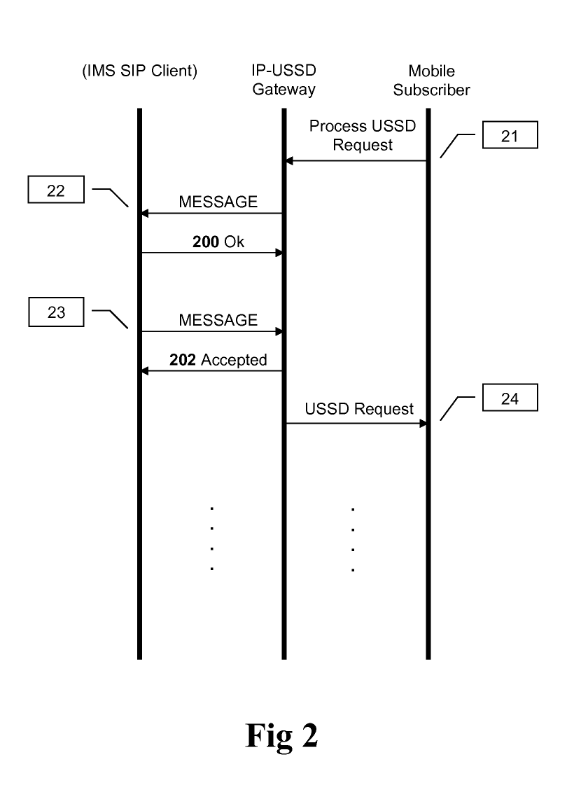

FIG. 2 shows graphically the signalling steps for a text-based dialogue started by the GSM subscriber.

The invention provides bi-directional and session based communication with the purpose of sending text information between SIP (Session Initiation Protocol) clients in IMS (Internet Protocol Multimedia Subsystem) networks and GSM mobile subscribers by using the SIP and USSD (Unstructured Supplementary Service Data) protocols.

Unstructured Supplementary Service Data (USSD) is a standard for transmitting information over GSM signalling channels. GSM networks all implement USSD services. USSD Phase 1, specified in GSM 02.90, only supports mobile initiated operation (pull operation), whereas USSD Phase 2, specified in GSM 03.90, supports network-initiated operation (pull and push operation). Phase 2 then allows the establishment of session based dialogues.

Typical usages of USSD include: allowing a mobile subscriber to query the available balance in pre-paid GSM services; requesting location based information; or invoking independent calling services, such as a callback service (thus facilitating cheaper phone charges while roaming), or interactive data service (e.g. stock quotes, sports results).

Necessary arrangements are made in mobile network applications for subscribers, who want to benefit from this service. For taking advantage of this service, mobile subscribers have to be registered to the service. The text-based interactive dialogue can be started by either the GSM subscriber or the IMS subscriber. The dialogue started by an IMS subscriber is shown in FIG. 1 and the dialogue started by a GSM subscriber is shown in FIG. 2.

In FIG. 1, an IMS SIP client sends a (SIP) text message to an IP-USSD Gateway—step 11. The IP-USSD Gateway includes a server for decoding the address (of a GSM mobile subscriber) to which the message will be sent. The SIP text message, in form of “MESSAGE”, is converted into a corresponding USSD message and sent to the GSM mobile subscriber with “USSD Request”—step 12. In the USSD message received, the mobile subscriber can see the name-surname information of the IMS subscriber along with the dialogue request. The GSM mobile subscriber answers the dialogue request by sending to the IP-USSD Gateway the “USSD Response”—step 13. The IP-USSD Gateway converts the received message into a SIP message and sends it to the SIP client as “MESSAGE”—step 14. The dialogue continues this way.

FIG. 2, by contrast, shows the dialogue initiated by a GSM mobile subscriber. The GSM subscriber sends the “Process USSD Request” message to start the dialogue over the mobile phone—step 21. The IP-USSD Gateway receiving this message carries out the decoding of the necessary address and converts it into a SIP message. The SIP message generated is then sent to the IMS subscriber—step 22. The IP-USSD Gateway can carry out the sending of the messages itself or by means of another USSD gateway, residing between. The SIP client answers the message received with MESSAGE—step 23—and this message is converted into a “USSD Request” message by the IP-USSD Gateway and sent to the mobile subscriber—step 24.

As the method described uses the widely established USSD service, it can be used with any type of mobile phones in GSM networks without needing networks supporting GPRS or more recent bearer technologies (such as UMTS/3G, LTE, WiMAX). In addition, when prepaid subscribers roam in different countries, the invention provides the possibility of communication using the USSD service.

As will readily be understood, network operators rendering GSM Services may implement the invention to establish text-based dialogues between their own mobile subscribers and IMS network subscribers. GSM network operators can thereby offer their customers otherwise unavailable, advanced chat and information services using USSD to communicate with the IMS networks.

1. A method for facilitating session-based text message communications between a first communications network and a second communications network, the first communications network being operable to deliver Internet Protocol multimedia services and the second communications network being operable to deliver messages that conform to a session-based message protocol, the method comprising:
receiving a session request signal from a given one of said communications networks, said session request signal including a text message;
translating the received request signal into a session request signal capable of being transported over the other of said communications networks; and
relaying the translated request signal to said other communications network, thereby establishing a text message communications session between the networks.

2. The method as claimed in claim 1, wherein the method further comprises:
receiving a session response signal from said other communications network;
translating the received response signal into a session response signal capable of being transported over said given communications network; and
relaying the translated response signal to said other communications network.

3. The method as claimed in claim 2, wherein the session response signal includes a further text message.

4. The method as claimed in claim 1, wherein the session request signal is received from the first communications network and conforms to the Session Initiation Protocol.

5. The method as claimed in claim 1, wherein the session request signal is received from the second communications network and conforms to a session-based message protocol.

6. The method as claimed in claim 1, wherein the text message includes name-surname information of the subscriber, from whom the session request signal originates.

7. An apparatus for facilitating session-based text message communications between a first communications network and a second communications network, the first communications network being operable to deliver Internet Protocol multimedia services and the second communications network being operable to deliver messages that conform to a session-based message protocol, the apparatus comprising:
first network interface for receiving session request signals from said first communications network and second network interface for receiving session request signals from said second communications network, said session request signals including text messages; and
a translator which is operable to convert received request signals from a given one of said communications networks into translated session request signals capable of being transported over the other of said communications networks;
wherein the first network interface and second network interface are further operable to relay the translated request signal to said other communications network, thereby establishing a text message communications session between the communications networks.

8. The apparatus as claimed in claim 7, wherein the translator is an IP-USSD Gateway residing between said first communications network and said second communications network.

9. The apparatus as claimed in claim 8, wherein session request signals received from the first communications network conform to the Session Initiation Protocol and are converted into translated session request signals conforming to the USSD message protocol.

10. The apparatus as claimed in claim 8 or claim 9, wherein session request signals received from the second communications network conform to the USSD message protocol and are converted into translated session request signals conforming to the Session Initiation Protocol.
